(19) United States
(12) Patent Application Publication
(10) Pub. No.: US 2011/0142012 A1
(43) Pub. Date: Jun. 16, 2011

(54) METHOD OF ALLOCATING CHANNEL TIME FOR VARIABLE BIT RATE (VBR) TRAFFIC, APPARATUS FOR PROCESSING DATA AND METHOD THEREOF

(76) Inventors: Beomjin Jeon, Seoul (KR); Joongheon Kim, Seoul (KR)

(21) Appl. No.: 13/054,864

(22) PCT Filed: Jul. 20, 2009
(86) PCT No.: PCT/KR09/03993

§ 371 Date: Jan. 19, 2011

(30) Foreign Application Priority Data
Jul. 20, 2008 (US) 61082218
Nov. 19, 2008 (KR) 10-2008-0115183

(51) Int. Cl. H04W 72/04

(52) U.S. Cl. 370/336

(57) ABSTRACT

A method of allocating a variable bit rate traffic in an unallocated channel time is disclosed. The present invention includes determining whether an unallocated channel time is great enough to allocate the channel time for VBR traffic when receiving a request for a channel time for the VBR traffic and allocating the VBR traffic channel time in a portion of the unallocated channel time. The method allocates an unallocated channel time by considering a channel time request of VBR traffic, thereby securing resource operation and management efficiency within a beacon interval.

### TECHNICAL FIELD

The present invention relates to a method of allocating a variable bit rate data traffic in an unallocated channel time existing within a beacon timeslot, and an apparatus for processing data and method thereof in a communication network.

### BACKGROUND ART

Generally, millimeter wave communication (mmWave) uses a carrier having a millimeter wavelength for high rate data transfer. In general, the millimeter wave frequency band is an unlicensed band and has been used for a communication services, radio astronomy, vehicle collision prevention, etc., in a limited manner.

Millimeter wave signals are able to provide a very high data rate on the order of several gigabits per second (Gbps). A millimeter wave transmitter, receiver, processor, and antenna may on a single chip. The antenna has a size of 1.5 mm or less. Moreover, because millimeter wave signals attenuate very quickly, inter-station interference maybe reduced.

Generally, communication traffic may be categorized as either constant bit rate (CBR) that transfers data at a constant data rate or variable bit rate (VBR) that transfers data at a variable data rate.

Because the CBR traffic has a constant data rate, it is trivial to predict the CBR traffic on a communication network. Because the VBR traffic has a variable data rate, a peak data rate exists. When the VBR traffic is not managed well, data packets may be dropped or other data transmission problems may result.

Channel characteristics on a wireless network are unstable, is not practical to use CBR transmission. Instead, VBR transmission is used to account for variations in the wireless channel. Therefore, it is important to accommodate VBR traffic to improve performance in a wireless network.

The VBR traffic is not constant like CBR traffic. Hence, once the actual data rate has been determined is compared to an average data rate. When the actual data rate is greater than the average data rate, the extra data packets are buffered. Once the actual data rate drops below the average data rate, the data packets buffered in the buffer are transmitted.

FIG. 1 is a graph depicting the characteristics of VBR traffic.

Referring to FIG. 1, a related art configures a buffer provided to a part for transmitting and receiving VBR traffic. And, a channel time at each terminal end is determined with reference to an average throughput.

When data is transmitted, if the data rate of the VBR traffic exceeds the average bit rate, the data is accumulated in a buffer. If the VBR traffic drops below the average bit rate, the data accumulated in the buffer is transmitted. Hence, a communication system may adapt to the transmission of the VBR traffic.

### DISCLOSURE OF INVENTION

### Technical Problem

Accordingly, the present invention is directed to a method of allocating channel time for variable bit rate (VBR) traffic, apparatus for processing data and method thereof that substantially obviates one or more of the problems due to limitations and disadvantages of the related art.

The present invention is to provide a method of allocating a variable bit rate traffic (VBR), by which an unallocated channel time is allocated by considering a channel time request of VBR traffic.

Additionally, the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### Technical Solution

To achieve these and other advantages and in accordance with the purpose of the present invention, as embodied and broadly described, a method of allocating a channel time for a variable bit rate (VBR) traffic for a station in a wireless communication network, the method including: determining whether an unallocated channel time is great enough to allocate the channel time for the VBR traffic when receiving a request for the channel time for the VBR traffic; and allocating the VBR traffic channel time in a portion of the unallocated channel time.

In another aspect of the present invention, a method of allocating channel times for a variable bit rate (VBR) traffic for stations in a wireless communication network, the method including: allocating a first VBR traffic channel time for a first station in a first unallocated channel time; determining whether a second unallocated channel time is great enough to allocate a second VBR traffic channel time when receiving a request from a second station for a second channel time for the second VBR traffic; and allocating the second VBR traffic channel time for the second station in a portion of the second unallocated channel time, wherein the second unallocated channel time is the unallocated channel time remaining after allocating the first VBR traffic channel time in the first unallocated channel time.

In another aspect of the present invention, a method for processing data in a station in a wireless communication network, the method including: requesting from a coordinator a channel time for VBR traffic to be transmitted on the wireless communication network; receiving timing allocation information for the VBR traffic channel time from the coordinator; and communicating data with another station during the VBR traffic channel time, wherein the VBR traffic channel time is allocated in a portion of an unallocated channel time after the coordinator determines whether the unallocated channel time is great enough to allocate the channel time for the VBR traffic.

In another aspect of the present invention, a method for processing data in a station in a wireless communication network, the method including: requesting from a coordinator a channel time for VBR traffic to be transmitted on the wireless communication network; receiving an allocation rejection message for the VBR traffic channel time from the coordinator; adjusting the channel time for the VBR traffic of the station; and requesting from the coordinator a channel time for the VBR traffic based upon the adjusted channel time, wherein the allocating rejection message is generated when an unallocated channel time is not great enough to allocate the requested channel time.

In another aspect of the present invention, an apparatus in a wireless communication network for processing data, the apparatus including: a communication module that receives data from an external station, and that transmits data to the external station; and a controller that controls the communication module to receive a request for a channel time for a VBR traffic, that determines whether an unallocated channel time is great enough to allocate the channel time for the VBR traffic, and that allocates the VBR traffic channel time in a portion of the unallocated channel time.

In another aspect of the present invention, an apparatus in a wireless communication network for processing data, the apparatus including: a communication module that transmits data to at least one external station and a coordinator, and that receives data from the at least one external station and a coordinator; and a controller that requests a channel time for VBR traffic from the coordinator, that controls the communication module to receive allocation information regarding the VBR traffic channel time from the coordinator, and that controls the communication module to communicate data with at least one external station during the VBR traffic channel time.

It is to be understood that both the foregoing general description and the following detailed description are exemplary and explanatory and are intended to provide further explanation of the invention as claimed.

### ADVANTAGEOUS EFFECTS

The present invention allocates an unallocated channel time by considering a channel time request of VBR traffic, thereby securing resource operation and management efficiency within a beacon interval.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a graph depicting the characteristics of VBR traffic;

FIG. 2 is a diagram depicting a beacon interval in a wireless data communication system according to an embodiment of the invention;

FIG. 3 is a diagram depicting a situation for accommodating traffic up to VBR-MAX according to one embodiment of the invention;

FIG. 4 is a diagram depicting a situation where a data transfer is allowed with a data rate of VBR-min below VBR-MAX;

FIG. 5 is a diagram depicting a situation where VBR-min for the requested traffic is greater than the unallocated channel time;

FIG. 6 is a diagram that depicts a situation where a plurality of wireless stations make a request to transmit VBR traffic;

FIG. 7 and FIG. 8 are diagrams that depict a process for transmitting two different traffic requests in the unallocated channel time;

FIG. 9 is a diagram depicting a situation where second traffic request is rejected;

FIG. 10 is a block diagram depicting a coordinator according to one embodiment of the invention; and

FIG. 11 is a block diagram of a station according to one embodiment of the invention.

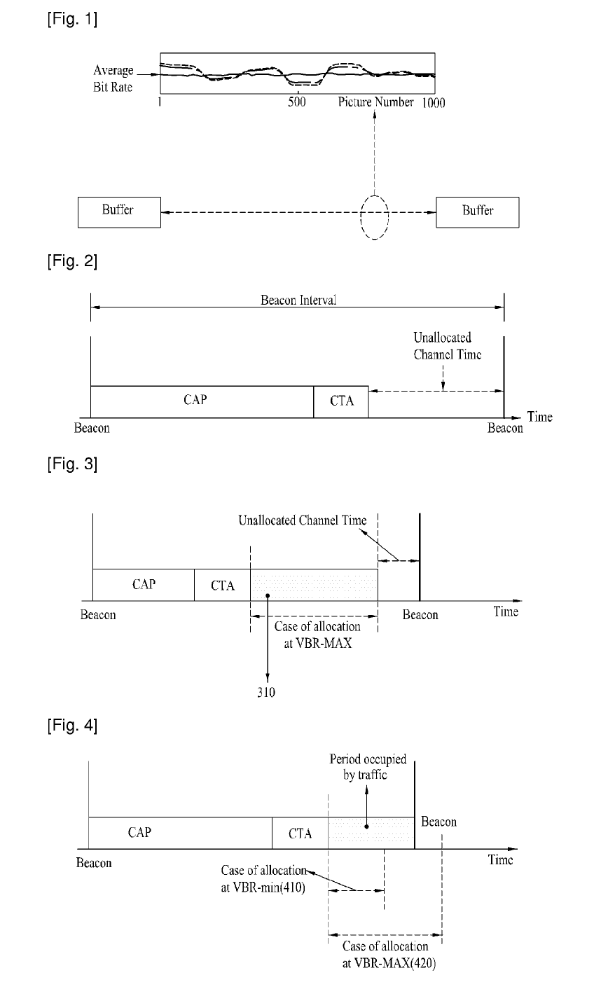

### BEST MODE FOR CARRYING OUT THE INVENTION

To achieve these and other advantages and in accordance with the purpose of the present invention, as embodied and broadly described, a method of allocating a channel time for a variable bit rate (VBR) traffic for a station in a wireless communication network, the method including: determining whether an unallocated channel time is great enough to allocate the channel time for the VBR traffic when receiving a request for the channel time for the VBR traffic; and allocating the VBR traffic channel time in a portion of the unallocated channel time.

In another aspect of the present invention, a method of allocating channel times for a variable bit rate (VBR) traffic for stations in a wireless communication network, the method including: allocating a first VBR traffic channel time for a first station in a first unallocated channel time; determining whether a second unallocated channel time is great enough to allocate a second VBR traffic channel time when receiving a request from a second station for a second channel time for the second VBR traffic; and allocating the second VBR traffic channel time for the second station in a portion of the second unallocated channel time, wherein the second unallocated channel time is the unallocated channel time remaining after allocating the first VBR traffic channel time in the first unallocated channel time.

In another aspect of the present invention, a method for processing data in a station in a wireless communication network, the method including: requesting from a coordinator a channel time for VBR traffic to be transmitted on the wireless communication network; receiving timing allocation information for the VBR traffic channel time from the coordinator; and communicating data with another station during the VBR traffic channel time, wherein the VBR traffic channel time is allocated in a portion of an unallocated channel time after the coordinator determines whether the unallocated channel time is great enough to allocate the channel time for the VBR traffic.

In another aspect of the present invention, a method for processing data in a station in a wireless communication network, the method including: requesting from a coordinator a channel time for VBR traffic to be transmitted on the wireless communication network; receiving an allocation rejection message for the VBR traffic channel time from the coordinator; adjusting the channel time for the VBR traffic of the station; and requesting from the coordinator a channel time for the VBR traffic based upon the adjusted channel time, wherein the allocating rejection message is generated when an unallocated channel time is not great enough to allocate the requested channel time.

In another aspect of the present invention, an apparatus in a wireless communication network for processing data, the apparatus including: a communication module that receives data from an external station, and that transmits data to the external station; and a controller that controls the communication module to receive a request for a channel time for a VBR traffic, that determines whether an unallocated channel time is great enough to allocate the channel time for the VBR traffic, and that allocates the VBR traffic channel time in a portion of the unallocated channel time.

In another aspect of the present invention, an apparatus in a wireless communication network for processing data, the apparatus including: a communication module that transmits data to at least one external station and a coordinator, and that receives data from the at least one external station and a coordinator; and a controller that requests a channel time for VBR traffic from the coordinator, that controls the communication module to receive allocation information regarding the VBR traffic channel time from the coordinator, and that controls the communication module to communicate data with at least one external station during the VBR traffic channel time.

It is to be understood that both the foregoing general description and the following detailed description are exemplary and explanatory and are intended to provide further explanation of the invention as claimed.

### Mode for the Invention

Reference will now be made in detail to an embodiment of the present invention, examples of which are illustrated in the accompanying drawings.

The following exemplary embodiments of the present invention may be modified into various forms and the scope of the present invention including the appended claims and their equivalents is not limited to the following embodiments.

A wireless communication network may include a coordinator and at least one station. In such a network is possible to have devices that may act either as a coordinator or a station as needed. The wireless network may use a beacon signal transmitted by the coordinator. The beacon signal may transmit control, timing, and status information to the stations in the wireless communications network. The beacon signal has a designated timeslot that allows the station to know a specific time to receive the beacon signal and it associated information. A beacon interval is defined as the time between the start of one beacon signal and the next beacon signal.

The current embodiment discloses a method of allocating VBR traffic in an unallocated channel time existing within the beacon interval. Because the data rate of VBR traffic is not a constant value, there exists a maximum data rate value and a minimum data rate value. In the current embodiment, the unallocated time channel in the beacon interval may be allocated based on the maximum and minimum VBR data rate values. Moreover, when two different VBR data traffic streams are transmitted, the allocated channel time may be able to carry both VBR data traffic streams based upon the maximum and minimum VBR data rates of each data traffic stream. Because the size of the unallocated channel time varies each beacon interval, reliable transmission of a beacon signal having the corresponding information is important. For isochronous traffic, a prescribed number of beacons maybe skipped, so an upper limit to the number that may be skipped needs to be determined

Because the VBR data traffic has a variable bit rate, the bit rate is not a constant value but a variable value. For VBR data traffic, maximum and minimum data rate values exist. The maximum value indicates the peak data rate in the VBR traffic. The minimum value indicates the lowest data rate in the VBR traffic. In the following description, a maximum VBR data rate is represented by VBR-MAX and a minimum VBR data rate is represented by VBR-min.

FIG. 2 is a diagram depicting a beacon interval in a wireless data communication system according to an embodiment of the invention. A typical beacon interval includes a contention access period (CAP) and a channel time allocation (CTA). The channel time allocation (CTA) may be named by a service period (SP).

FIG. 2 shows a situation where there is unallocated channel time. Actually, the unallocated channel time may exist in several places in the beacon interval. For example, for video data traffic, the data is periodic in nature due to the fixed frame and scan rates of video frames, but because of various compression techniques used on digital video data, the amount of data for each period may vary. Hence, the unallocated channel time may appear between the video data elements.

When unallocated channel time is present as explained above, a wireless network station may make a request to use the unallocated channel time. This request may include the values for VBR-MAX and VBR-min relating to the VBR data traffic to be transmitted during the unallocated channel time. A wireless communication network coordinator may determine whether requested traffic may be accommodated in an unallocated channel time based upon the VBR-MAX and VBR-min values.

FIG. 3 is a diagram depicting a situation for accommodating traffic up to VBR-MAX according to one embodiment of the invention.

Referring to FIG. 3, if the data rate of the traffic requested of the coordinator is smaller than a previous unallocated channel time period, it is able to use an unallocated channel time indicated by 310 corresponding to data transmission at VBR-MAX. In this case, the unallocated channel time is reduced into the time indicated by 310.

FIG. 4 is a diagram depicting a situation where a data transfer is allowed with a data rate of VBR-min below VBR-MAX.

Referring to FIG. 4, the unallocated channel time is greater than VBR-MIN but less than VBR-MAX. In this situation data with a data rate of VBR-MAX [420] cannot be accommodated because the unallocated time is not large enough. On the other hand, data with a data rate of VBR-min may be transmitted because the unallocated channel time is greater than VBR-min. Therefore, data traffic is selected that can fit within the unallocated channel time. Because the unallocated channel time is greater VBR-min, there will be data traffic that can fit within the unallocated channel time.

Thus, if the previous unallocated channel time portions are entirely used, there is no remaining unallocated channel time.

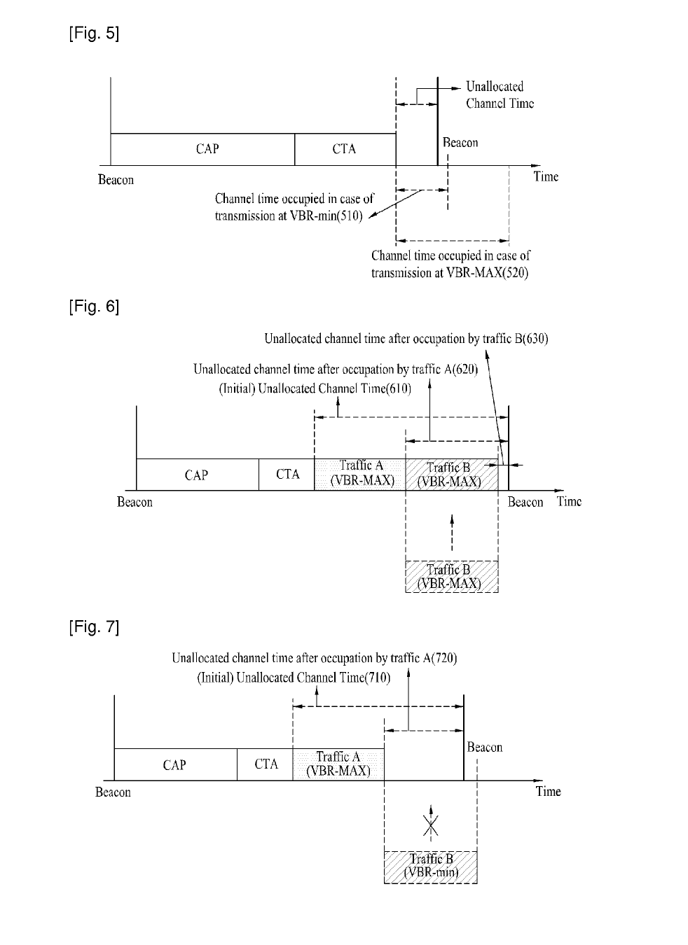

FIG. 5 is a diagram depicting a situation where VBR-min for the requested traffic is greater than the unallocated channel time.

Referring to FIG. 5, the unallocated channel time is unable to accommodate traffic with a data rate of VBR-min, so, the requested traffic is rejected.

FIG. 6 is a diagram that depicts a situation where a plurality of wireless stations make a request to transmit VBR traffic.

Referring to FIG. 6, if the unallocated channel time 610 allows the first traffic (traffic A) to be transmitted at a data rate of VBR-MAX, the above-described process is adopted.

If the remaining unallocated channel time 620 allows the second traffic (traffic B) to be transmitted at a data rate of VBR-MAX, then there is an unallocated channel time 630 shown in FIG. 6 after both requests are satisfied.

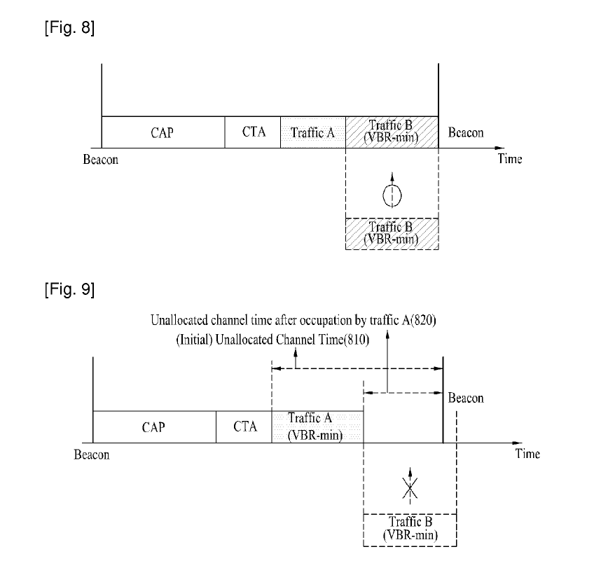

FIG. 7 and FIG. 8 are diagrams that depict a process for transmitting two different traffic requests in the unallocated channel time.

Referring to FIG. 7, after first traffic (traffic A) has been accommodated in the unallocated channel time with a data rate of VBR-MAX, the remaining unallocated channel time is less than VBR-min for a second traffic (traffic B), so the second traffic is not accommodated because the remaining unallocated channel time is insufficient.

If so, referring to FIG. 8, it is possible to reduce the time period secured by the first traffic (traffic A). In particular, while traffic A is allocated a channel time, when a request for the traffic B is received, if the remaining unallocated channel time is not great enough to accommodate VBR-min for traffic B, space may be provided for traffic B by reducing the channel time allocated to traffic A. Thus, by reducing the period of VBR-MAX for traffic A to VBR-min for the first traffic (traffic A) and then VBR-min of the second traffic (traffic B) may fit in the remaining unallocated channel time. If traffic B is not able to be accommodated in this way, it is preferable that the data transfer of the second traffic (traffic B) is rejected.

In this above case, because the channel time allocated to the first traffic (traffic A) is reduced, beacon signal may communicate in the next beacon signal that the previously allocated channel time for the traffic is reduced.

The above-described channel time allocation process may be modified to include more than two sets of traffic. The multiple sets of traffic may all be accommodated if there is enough unallocated channel time.

FIG. 9 is a diagram depicting a situation where second traffic request is rejected.

Referring to FIG. 9, while a first traffic (traffic A) occupies a portion of the unallocated channel time, a second traffic request (traffic B) is received. In this case, if the unallocated channel time is not enough despite using VBR-min for both of the first traffic (traffic A) and the second traffic (traffic B), there is not sufficient time for traffic B. Therefore, the second traffic is rejected, and the first traffic (traffic A) continues to occupy its originally allocated channel time.

Meanwhile, if the request for the second traffic is rejected, it is possible to repeat the request and adjust the time requirements for the second traffic.

For isochronous traffic, a prescribed number of beacons may be skipped. In order to prevent losing information indicating that the channel time allocated to previous traffic has changed, an upper limit may be set for the number of beacons that may be skipped. In this case, if a corresponding maximum skip time is exceeded, a station may make a request for a beacon signal.

When a number of traffic requests are made for the unallocated channel time, a coordinator obtains and uses priority information in order provide the highest priority traffic requests the first opportunity to utilize the unallocated channel time. As unallocated channel time remains available, the next higher priority traffic may be accommodated if possible.

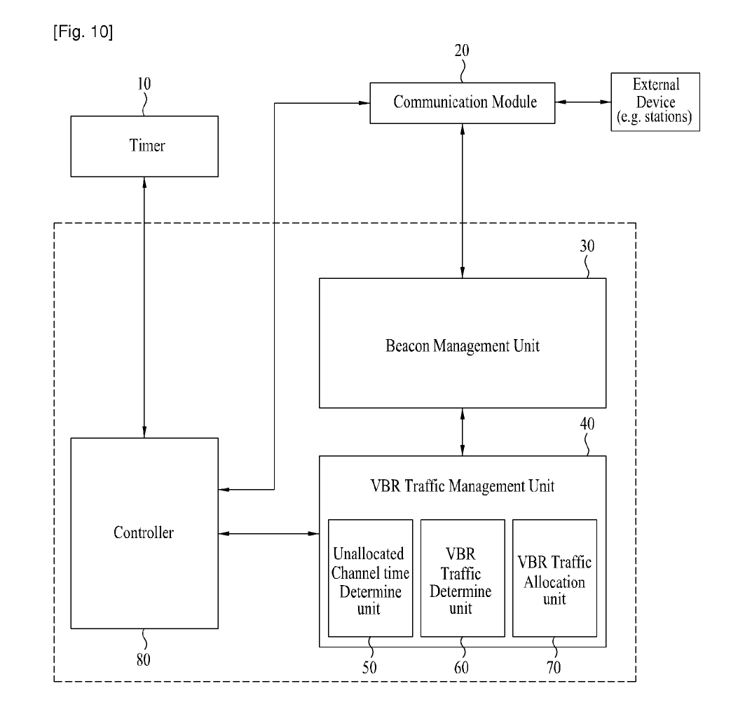

FIG. 10 is a block diagram depicting a coordinator according to one embodiment of the invention.

Referring to FIG. 10, the coordinator may include a timer 10, a communication module 20, a beacon management unit 30, a VBR traffic management unit 40 and a controller 80.

The timer 10 indicates a start and end of a beacon interval. Further, the timer 10 provides timing information within the beacon interval.

The communication module 20 transmits and receives data using information signals between a station and a coordinator.

The beacon management unit 30 manages the beacon signal. In this case, the beacon management unit 30 produces the beacon signal that provides information to other stations. For instance, a beacon signal include scheduling information such as allocation information of a channel time for data communication, allocation information for VBR traffic channel time, etc.

The VBR traffic management unit 40 may include an unallocated channel time determining unit 50, a VBR traffic determining unit 60 and a VBR traffic allocation unit 70.

When a request for allocating a VBR traffic channel time is received from a station, the unallocated channel time determining unit 50 determines whether an unallocated channel time exists within a beacon interval.

If a station makes a request for unallocated traffic channel time, both VBR-MAX and VBR-min values may be included in the request. If so, the VBR traffic determining unit 60 calculates and determines a proper VBR traffic channel time by considering the relationship between an unallocated channel time and the requested VBR-MAX or VBR-min value.

In particular, as mentioned in the foregoing description, if the unallocated channel time is greater than VBR-MAX, the VBR traffic determining unit 60 allocates the VBR-MAX value. If the unallocated channel time is smaller than the VBR-MAX value and greater than the VBR-min value, the VBR traffic determining unit 60 may determine that the VBR-min value should be allocated. If the unallocated channel time is smaller than the VBR-min value, the VBR traffic determining unit 60 may determine that the request should be rejected.

The VBR traffic allocation unit 70 allocates an actual VBR channel time based on the VBR traffic channel time derived by the VBR traffic determining unit 60.

When a request for a VBR traffic channel time is received from a station, the controller 80 controls the beacon management unit 30 to transmit a beacon signal indicating a proper channel time by considering the analysis and determination of the VBR traffic management unit 40.

Meanwhile, although the beacon management unit 30 and the VBR traffic management unit 40 are described as elements separate from the controller 80, it is understood that the controller 80 may perform the functions of the beacon management unit 30 and the VBR traffic management unit 40.

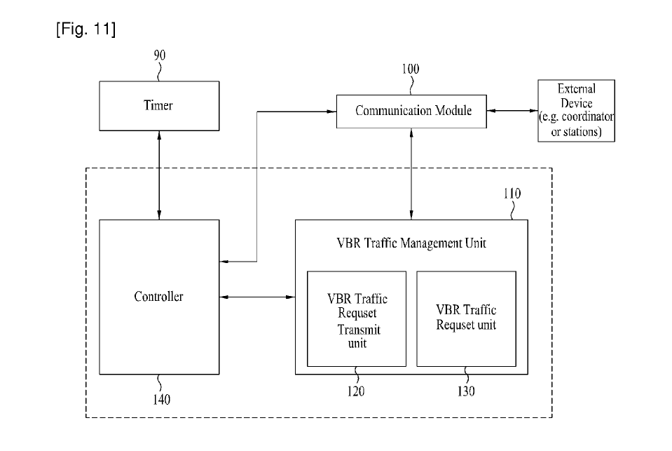

FIG. 11 is a block diagram of a station according to one embodiment of the invention.

Referring to FIG. 11, a station includes a timer 90, a communication module 100, a VBR traffic management unit 110 and a controller 140.

The timer 90 in indicates a start and end of a beacon interval. Further, the timer 90 provides timing information within the beacon interval.

The communication module 100 transmits and receives data using information signals between the station, other stations and/or the coordinator.

The VBR traffic management unit 110 may include a VBR traffic request transmit unit 120 and a VBR traffic request unit 130. The VBR traffic request unit 130 determines the VBR traffic max channel time and the VBR traffic min channel time. The VBR traffic request transmit unit 120 transmits the VBR traffic channel time determined by the VBR traffic request unit 130 to the coordinator via the communication module 100.

The controller 140 controls the VBR traffic management unit 110 to determine the necessary VBR traffic channel time value. The controller 140 controls a VBR traffic channel time to be allocated by transmitting the determined VBR traffic channel time value to the coordinator via the communication module 100. The controller 140 controls the VBR traffic to be transmitted during the allocated VBR traffic channel time.

Although the VBR traffic management unit 110 is described as an element separate from the controller 140, it is understood that the controller 140 perform the functions of the VBR traffic management unit 110.

### INDUSTRIAL APPLICABILITY

Accordingly, the present invention relates to a method of method of allocating a VBR traffic for an unallocated channel time existing within a beacon interval and is applicable to such a system as the mmWave using a directional beam link signal and the like.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A method of allocating a channel time for a variable bit rate (VBR) traffic for a station in a wireless communication network, the method comprising:
determining whether an unallocated channel time is great enough to allocate the channel time for the VBR traffic when receiving a request for the channel time for the VBR traffic; and
allocating the VBR traffic channel time in a portion of the unallocated channel time.

2. The method of claim 1, wherein the request received from the station includes a maximum channel time and a minimum channel time for the VBR traffic of the station.

3. The method of claim 2, wherein the determining step further comprises:
determining whether the unallocated channel time is great enough to allocate the maximum channel time for the VBR traffic of the station: and
determining whether the unallocated channel time is enough to allocate a channel time between the minimum channel time and the maximum channel time for the VBR traffic when the unallocated channel time is not great enough to allocate the maximum channel time.

4. The method of claim 2, wherein the determining step further comprises:
determining whether the unallocated channel time is great enough to allocate the minimum channel time for the VBR traffic; and
rejecting the request of the station when the unallocated channel time is not enough to allocate the minimum channel time.

5. A method of allocating channel times for a variable bit rate (VBR) traffic for stations in a wireless communication network, the method comprising:
allocating a first VBR traffic channel time for a first station in a first unallocated channel time;
determining whether a second unallocated channel time is great enough to allocate a second VBR traffic channel time when receiving a request from a second station for the second VBR traffic; and
allocating the second VBR traffic channel time for the second station in a portion of the second unallocated channel time,
wherein the second unallocated channel time is the unallocated channel time remaining after allocating the first VBR traffic channel time in the first unallocated channel time.

6. The method of claim 5, wherein the request received from the second station includes a maximum channel time and a minimum channel time for the second VBR traffic.

7. The method of claim 6, wherein the determining step further comprises:
determining whether the second unallocated channel time is great enough to allocate the maximum channel time for the second VBR traffic; and
determining whether the second unallocated channel time is great enough to allocate a channel time between the minimum channel time and the maximum channel time for the second VBR traffic when the unallocated channel time is not enough to allocate the maximum channel time.

8. The method of claim 6, wherein the determining step further comprises:
determining whether the second unallocated channel time is great enough to allocate the minimum channel time for the second VBR traffic; and
when the second unallocated channel time is not great enough to allocate the minimum channel time of the second VBR traffic, adjustin8 the first VBR traffic channel time to allocate the minimum channel time for the second VBR traffic.

9. The method of claim 8, wherein the adjusting step further comprises:
reducing the previously allocated first VBR tragic channel time to a minimum channel time for the first VBR traffic.

10. The method of claim 6, wherein the determining step further comprises:
determining whether the second unallocated channel time is great enough to allocate the minimum channel time for the second VBR traffic; and
rejecting the request of the second station when the second unallocated channel time is not great enough to allocate the minimum channel time for the second VBR traffic.

11. A method for processing data in a station in a wireless communication network, the method comprising:
Requesting to a coordinator a channel time for VBR traffic to be transmitted on the wireless communication network;
receiving timing allocation information for the VBR traffic channel time from the coordinator; and
communicating data with another station during the VBR traffic channel time,
wherein the VBR traffic channel time is allocated in a portion of an unallocated channel time after the coordinator determines whether the unallocated channel time is great enough to allocate the channel time for the VBR traffic.

12. The method of claim 11, wherein the requesting of the channel time includes a maximum channel time and a minimum channel time for the VBR traffic.

13. The method of claim 12, wherein the VBR traffic channel time is the maximum channel time for the VBR traffic.

14. The method of claim 12, wherein the VBR traffic channel time is a channel time between the minimum channel time and the maximum channel time for the VBR traffic.

15. A method for processing data in a station in a wireless communication network, the method comprising:
Requesting to a coordinator a channel time for VBR traffic to be transmitted on the wireless communication network;
receiving an allocation rejection message for the VBR traffic channel time from the coordinator;
adjusting the channel time for the VBR traffic of the station; and
requesting to the coordinator a channel time for the VBR traffic based upon the adjusted channel time,
wherein the allocating rejection message is generated when an unallocated channel time is not great enough to allocate the requested channel time.

16. An apparatus in a wireless communication network for processing data, the apparatus comprising:
a communication module configured to receive data from an external station, and transmit data to the external station; and
a controller configured to control the communication module to receive a request for a channel time for a VBR traffic, determine whether an unallocated channel time is great enough to allocate the channel time for the VBR traffic, and allocate the VBR traffic channel time in a portion of the unallocated channel time.

17. The apparatus of claim 16, wherein the controller is further configured to control the communication module to transmit the allocated VBR traffic channel time.

18. An apparatus in a wireless communication network for processing data, the apparatus comprising:
a communication module configured to transmit data to at least one external station and a coordinator, and receive data from the at least one external station and a coordinator; and
a controller configured to request a channel time for VBR traffic to the coordinator, control the communication module to receive allocation information regarding the VBR traffic channel time from the coordinator, and control the communication module to communicate data with at least one external station during the VBR traffic channel time.

19. The apparatus of claim 18, wherein the VBR traffic channel time is allocated in a portion of an unallocated channel time after the coordinator determines whether the unallocated channel time is great enough to allocate the channel time for the VBR traffic.
